(19) United States
(12) Patent Application Publication
(10) Pub. No.: US 2010/0018918 A1
(43) Pub. Date: Jan. 28, 2010

(54) METHOD AND DEVICE FOR THE AEROBIC TREATMENT OF WASTE WATER

(75) Inventors: George Troubounis, Munich (DE); Dieter Efinger, Kumhausen (DE); Werner Gessler, Ravensburg-Schmalegg (DE); Lucas Menke, Munich (DE)

Correspondence Address: GIFFORD, KRASS, SPRINKLE,ANDERSON & CITKOWSKI, P.C, PO BOX 7021, TROY, MI, 48007-7021, US

(73) Assignee: MERI ENTSORGUNGSTECHNIK FUER DIE PAPIERINDUSTRIE, Munich (DE)

(21) Appl. No.: 12/519,295

(22) PCT Filed: Jun. 18, 2007
(86) PCT No.: PCT/EP07/05352

§ 371 Date: Sep. 1, 2009

(30) Foreign Application Priority Data
Dec. 20, 2006 (DE) 10 2006 060 426.1

(51) Int. Cl. C02F 3/26; C02F 1/52; C02F 1/66; C02F 1/72

(52) U.S. Cl. 210/604; 210/151

(57) ABSTRACT

The present invention relates to a method for cleaning waste water, particularly for the continuous cleaning of waste water in the paper industry, wherein oxygen or an oxygen-containing gas and waste water to be cleaned are delivered to an aerobic reactor, the waste water is brought into contact with aerobic microorganisms in an aerobic reactor in order to degrade impurities contained in the waste water, and the cleaned waste water is delivered out of the aerobic reactor. At least a part of the waste water undergoes a pressure release flotation step before being fed into or after being delivered out of the aerobic reactor for the purpose of at least partial softening. In addition, the present invention relates to a device suitable for carrying out the method according to the invention.

The present invention relates to a method for the purification of waste water, in particular for the continuous purification of waste water in the paper making industry, wherein oxygen or a gas containing oxygen and waste water to be purified are supplied to an aerobic reactor, the waste water is brought into contact with aerobic microorganisms in the aerobic reactor to break down impurities contained in the waste water, and the purified waste water is drained from the aerobic reactor. The present invention furthermore relates to an apparatus suitable for the carrying out of the method in accordance with the invention.

A plurality of mechanical, chemical and biological processes and corresponding reactors are known for waste water purification. In biological waste water purification, the waste water to be purified is brought into contact with aerobic or anaerobic microorganisms which break down the organic impurities contained in the waste water predominantly to carbon dioxide and water in the case of aerobic microorganisms and predominantly to carbon dioxide and methane in the case of anaerobic microorganisms.

A so-called MBBR (“moving bed bioflm reactor”) has been used for some time as the reactor for the aerobic waste water purification. In this reactor, the aerobic microorganisms are applied to a carrier material which, for example, has the form of a framework which is kept in suspension during the carrying out of the method by the waste water guided through the reactor and by the aeration which takes place for the purpose of supplying oxygen. To keep the carrier material with the microorganisms growing thereon in the reactor, the water to be drained from the reactor is guided through a filter which has a sufficiently small opening diameter so that the carrier material permeated with the microorganisms does not pass through the filter.

A considerable problem in the purification of waste water in an aerobic reactors is the water hardness of the waste water or the carbonates and hydrogen carbonates contained in the waste water because the carriers used in aerobic reactors and permeated with microorganisms represent seed crystals for limescale during the operation of the reactor due to their structure and size. Limescale of this type on the carriers, however, impairs their function. If namely lime is deposited on the carriers permeated with microorganisms, their specific weight increases so that they are no longer held in suspension in the operation of the aerobic reactor and fall to the bottom of the reactor and can there no longer participate in the purification process. The metabolic activity of the aerobic microorganisms also effects a shift in the lime/carbon dioxide balance due to the generation of hydrogen carbonate ions (HCO₃—) among other things, which further promotes a lime precipitation onto the microorganism pellets. The water hardness of the waste water must be reduced to avoid this.

An apparatus is known from DE 199 18 695 A1 for the aerobic treatment of waste water from the paper making industry which has a turbulence zone with a waste water supply opening into this zone and with an oxygen supply for the swirling of the waste water and a clarification zone, with the zones being connected to one another via a passage for the water treated in the turbulence zone and with clear water and solids separating from one another and being removed separately in the clear zone. On the operation of this apparatus, the aerobic microorganisms present in the waste water are converted to biomass and carbon dioxide while consuming oxygen so that lime which is precipitated as a deposit forms during the swirling. At the same time, colloidally dissolved or suspended organic components are precipitated. To achieve a sufficient precipitation of the organic and inorganic charges, the dwell time of the waste water to be purified should amount to between 3 and 10 hours in the apparatus. Such long dwell times, however, induce a low throughput of the apparatus per time so that the method currently operated therewith is also very complex and/or expensive.

It is therefore the object of the present invention to provide a simple and cost-effective method as well as a corresponding apparatus for the purification of waste water, in particular for the purification of waste water in the paper making industry, wherein the impurities contained in the waste water can be efficiently broken down while avoiding the aforesaid problems.

This object is satisfied in accordance with the invention by a method in accordance with claim 1 and in particular by a method for the purification of waste water, in particular for the continuous purification of waste water in the paper making industry, wherein oxygen or a gas containing oxygen and waste water to be purified is supplied to an aerobic reactor, the waste water is brought into contact with aerobic microorganisms in the aerobic reactor to break down contaminants contained in the waste water, and the purified waste water is drained from the aerobic reactor, with at least some of the waste water being subjected to a dissolved air flotation step for the purpose of at least partial softening before the supply into the aerobic reactor or after the draining from the aerobic reactor.

Since the waste water to be purified is subjected to a dissolved air flotation step either before the supply into the aerobic reactor or after the draining from the aerobic reactor, the water hardness of the waste water can be reduced by precipitation of lime so that disturbing lime precipitation in the aerobic reactor can be reliably prevented. A further particular advantage of the method in accordance with the invention comprises the dissolved air flotation step being able to be carried out at least partly in a microflotation device which is frequently provided for the separation of particulate matter in apparatus for waste water purification known in the prior art and including an aerobic reactor so that only slight modifications to already existing systems are required for the carrying out of the method in accordance with the invention. Furthermore, a softening of the waste water can be achieved fast and efficiently using the dissolved air flotation step so that the corresponding apparatus can be operated at a high throughput of waste water per time.

At least partial softening is to be understood in the sense of the present invention as the reduction of the water hardness.

Dissolved air flotation is to be understood in the sense of the present invention as a separation process in which a gas dissolved under pressure in water degasses on a subsequent pressure reduction (expansion) and the degassed gas is deposited on suspended solid particles while rising so that their flotation is made possible.

In the dissolved air flotation step carried out in accordance with the invention, the waste water is preferably set to a neutral or alkaline pH, is dosed with gas and is pressurized before the waste water treated in this way is exposed to a reduced pressure. Whereas a precipitation of lime is promoted by the setting of a neutral or alkaline pH, the subsequent addition of pressurized gas, pressurization and subsequent exposure to a pressure reduced with respect to the pressurization or to an expansion effect the bubbling of small gas bubbles in the waste water mixture, with the individual gas bubbles flowing upwardly through the mixture and in so doing taking along the precipitated lime flakes which can thus easily be separated from the waste water.

To achieve an efficient lime precipitation in the dissolved air flotation step, it is proposed in a further development of the idea of the invention to set the waste water to a pH between 7 and 10, preferably between 7 and 9 and particularly preferably between 7.5 and 8.5. Suitable pH setting agents for the setting of the pH into the aforesaid ranges include, for example sodium hydroxide solution (NaOH), potassium hydroxide solution (KOH) and calcium hydroxide (Ca(OH)₂). The setting of the pH can naturally also take place in all other ways known to the person of ordinary skill in the art; for example, in that a chemical compound such as urea is converted catalytically, e.g. enzymatically, to a base compound such as ammonia.

To support the lime precipitation and to be able to separate the lime flakes formed in the dissolved air flotation step particularly easily from the waste water, it has proved to be advantageous to add at least one precipitant and/or at least one flocculation aid to the waste water before or during the dissolved air flotation step. Whereas the precipitant facilitates the lime precipitation, the flocculation aid effects the formation of lime flakes with a structure and size desired for a simple separation thereof.

Whereas polyaluminum chloride has proven itself as a precipitant, a preferred example for a suitable flocculation aid is polyacrylamide.

Generally, the dissolved air flotation step can take place before or after the supply of the supplied waste water into the aerobic reactor, i.e. the waste water to be purified can be supplied to a dissolved air flotation device before the supply into the aerobic reactor (upstream process management), before it is drained from the dissolved air flotation device and is supplied directly or indirectly to the aerobic reactor or the waste water to be purified can first be supplied to the aerobic reactor (downstream process management) before the waste water drained from the aerobic reactor is supplied to a dissolved air flotation device. It has proved to be particularly advantageous within the framework of the present invention to supply the waste water to a dissolved air flotation device before the supply into the aerobic reactor because the dissolved air flotation device can then be combined with a microflotation device present in existing systems for the separation of particulate matter.

Independently of whether the upstream or the downstream process management is selected, it is proposed in a further development of the idea of the invention to guide back the waste water into the aerobic reactor at least partly after the dissolved air flotation step.

In the method in accordance with the invention, the temperature of the waste water, in particular of the waste water supplied to the aerobic reactor, is preferably regulated and/or monitored to set the ideal temperature for the microorganisms contained in the aerobic reactor.

In accordance with a preferred embodiment for the downstream—with respect to the aerobic purification step—carrying out of the dissolved air flotation step, provision is made to supply the waste water to be purified continuously to a dissolved air flotation device in which the dissolved air flotation step takes place and to mix it there with at least some of the waste water drained from the aerobic reactor and to drain at least partly softened waste water continuously from the dissolved air flotation device which is guided completely or partly into the aerobic reactor.

Alternatively to this, it is also possible to supply the waste water to be purified continuously to a dissolved air flotation device in which the dissolved air flotation step takes place and to mix it there with at least some of the waste water continuously drained from the aerobic reactor and to drain at least partly softened waste water continuously from the dissolved air flotation devices with the at least partly softened waste water being separated into two part flows and one part flow being guided into the aerobic reactor, whereas the other part flow is drained from the apparatus and is used again in a production process.

It has also proved to be advantageous with the downstream process management to separate the purified waste water continuously drained from the aerobic reactor into two part flows of which one is removed from the apparatus, with the other part flow being led back into the dissolved air flotation device.

In the last-named embodiment, it has proved to be advantageous that the part flow supplied to the dissolved air flotation device amounts, with respect to the total flow drained from the aerobic reactor, to between 5 and 80%, and particularly preferably to between 30 and 50%.

The process management preferably takes place such that the water hardness in the dissolved air flotation step is reduced by at least 5%, particularly preferably by at least 20% and very particularly preferably by at least 40%.

In the method in accordance with the invention, all the types of aerobic reactors known to the skilled person can be used, with MBBR or activated sludge tanks being named only as examples. The aerobic reactor to be used can in particular contain all the known aeration systems for the supply of the oxygen or of the gas containing oxygen required for the aerobic microorganisms such as a jet aerator, a volume aerator, a surface aerator and the like. The aerobic reactor is particularly preferably made as an MBBR. The microorganisms can be retained in the aerobic reactor either by suitable filters which are positioned in front of the drainage line for the purified water or can be separated from the water downstream of the reactor in a separation device and guided back into the reactor again.

In addition to the treatment of the waste water in the aerobic reactor in accordance with the invention and to the dissolved air flotation step, the method in accordance with the invention can include the use of further biological treatment stages such as that of one or more further aerobic reactors and/or that of one or more anaerobic reactors. The total number of the aerobic and, optionally, anaerobic reactors preferably amounts to 2 to 6.

A further subject of the present invention is an apparatus for the purification of waste water which is in particular suitable for the carrying out of the previously described method in accordance with the invention.

In accordance with the invention, the apparatus includes at least one reactor for the aerobic purification of waste water having at least one supply line for the supply of waste water to be purified into the reactor, at least one gas supply line for the supply of oxygen or for the supply of a gas containing oxygen into the reactor as well as at least one drainage line for the drainage of purified waste water from the reactor, with the apparatus furthermore including a dissolved air flotation device having a dissolved air flotation reactor, said dissolved air flotation device being connected to the at least one drainage line of the aerobic reactor via a dissolved air flotation supply line such that at least one part flow of the purified waste water removed from the aerobic reactor via the drainage line can be led into the dissolved air flotation reactor, with the dissolved air flotation device having at least one supply line for a pH setting agent and the dissolved air flotation device furthermore including a return line leading directly or indirectly from the dissolved air flotation reactor to the aerobic reactor. In this respect, the dissolved air flotation device can be connected to the at least one drainage line of the aerobic reactor via a dissolved air flotation supply line such that at least one part flow of the purified waste water removed from the aerobic reactor via the drainage line is led directly or indirectly, i.e. via further apparatus parts, into the dissolved air flotation reactor.

The apparatus preferably has a waste water supply line which is arranged downstream of the aerobic reactor and is connected in a liquid conducting manner to a dissolved air flotation supply line or to the dissolved air flotation reactor.

It is furthermore preferred for the dissolved air flotation device to have at least one supply line for a precipitant and/or a flocculation aid.

It is proposed in a further development of the idea of the invention to provide at least one supply line for a pressurized gas in the dissolved air flotation device.

In accordance with a further preferred embodiment of the present invention, the dissolved air flotation device has a gas dissolving device which is connected to the dissolved air flotation reactor via a line and into which the pressurized gas supply line opens.

In addition, it has proved to be expedient for the waste water supply line to open into a mixer unit and to open from there via a supply line into the dissolved air flotation reactor, with the mixer unit preferably having a supply line for pH setting agents and/or a supply line for precipitants and/or flocculation aids.

The return line of the dissolved air flotation device preferably opens directly into the inflow region of the aerobic reactor.

In accordance with a further preferred embodiment of the present invention, provision is made for the apparatus to have a waste water supply line which is arranged upstream of the aerobic reactor and is connected in a fluid conducting manner to the supply line of the aerobic reactor.

To set a temperature which is in particular ideal for the microorganisms contained in the aerobic reactor, the apparatus preferably has a temperature setting device which is preferably arranged in the return line. The temperature setting device is preferably a heat exchanger or a cooling device, for example a cooling tower.

The aerobic reactor preferably has a reactor tank in whose lower region the supply line to the aerobic reactor is provided, at least one aeration device for the introduction of oxygen or of a gas containing oxygen, at least one inflow distributor for the mixing of the waste water supplied to the reactor with the medium located in the reactor and at least one overflow arranged at the upper reactor tank for the draining of purified water to the reactor drainage line.

In accordance with a further preferred embodiment of the present invention, the gas supply line of the aerobic reactor opens into an aeration device which is preferably made as a jet aeration, as a volume aeration or as a surface aeration.

It is proposed in a further development of the invention that the apparatus includes one or more further aerobic reactors and/or one or more anaerobic reactors in addition to the aerobic reactor.

The apparatus preferably includes a sludge separation device which is disposed downstream of the aerobic reactor and from which a sludge return line preferably leads to the aerobic reactor.

The present invention will be described in the following purely by way of example with reference to advantageous embodiments and to the enclosed drawings.

There are shown:

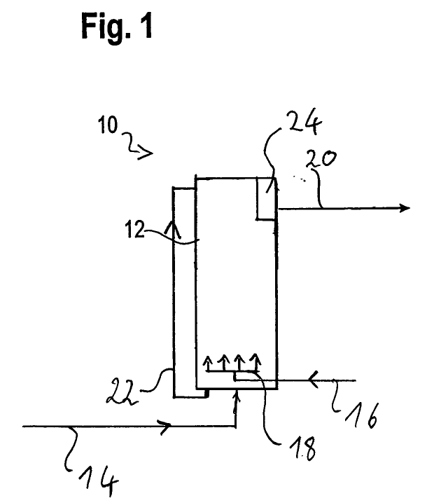

FIG. 1 a schematic view of an apparatus for the purification of waste water in the paper making industry in accordance with the prior art;

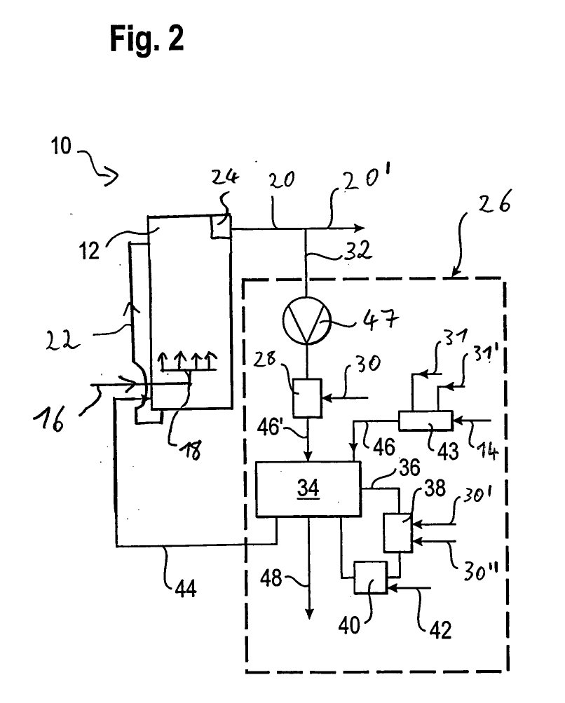

FIG. 2 a schematic view of an apparatus for the purification of waste water in the paper making industry in accordance with a first embodiment of the present invention;

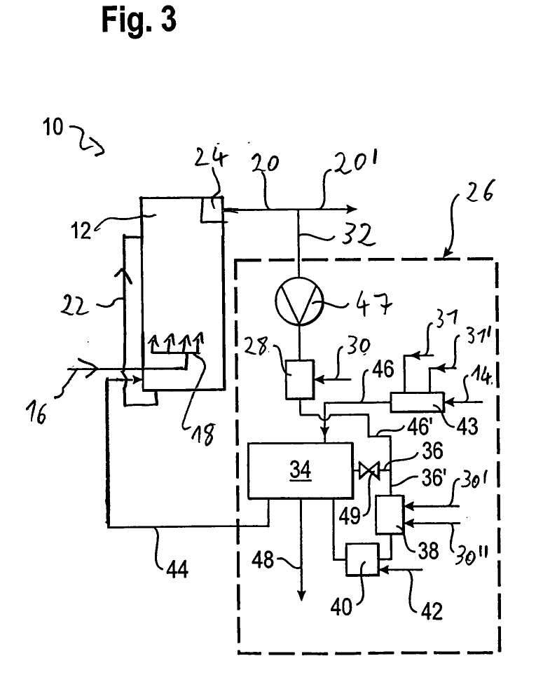

FIG. 3 a schematic view of an apparatus for the purification of waste water in the paper making industry in accordance with a second embodiment of the present invention;

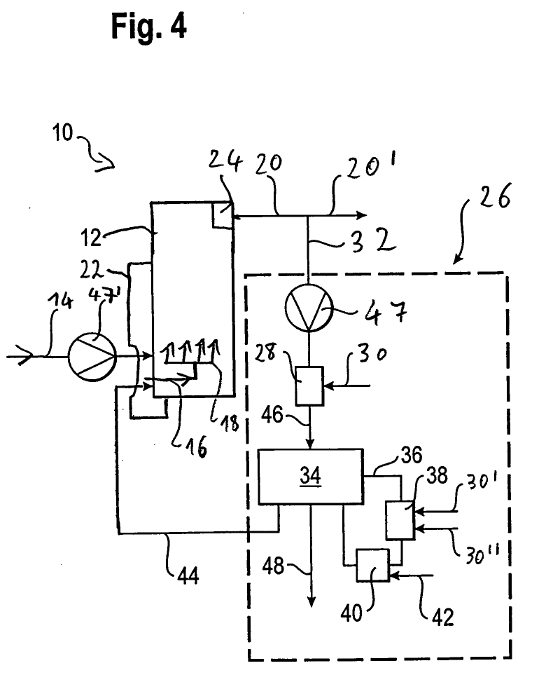

FIG. 4 a schematic view of an apparatus for the purification of waste water in the paper making industry in accordance with a third embodiment of the present invention;

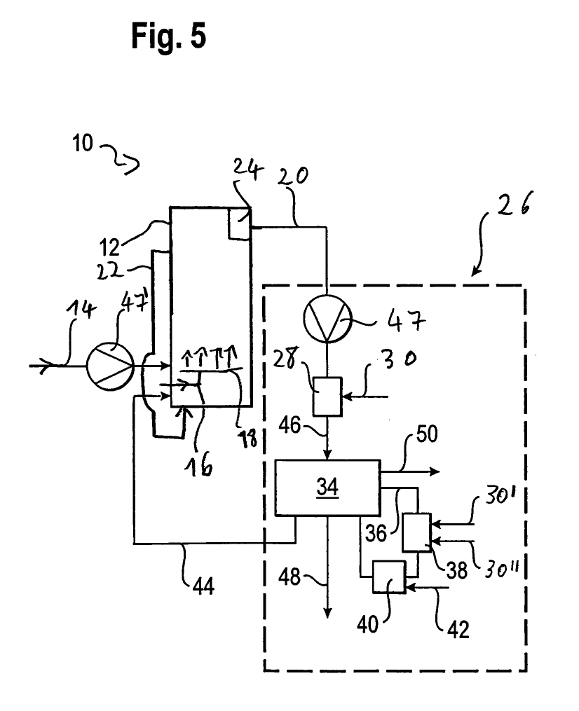

FIG. 5 a schematic view of an apparatus for the purification of waste water in the paper making industry in accordance with a fourth embodiment of the present invention;

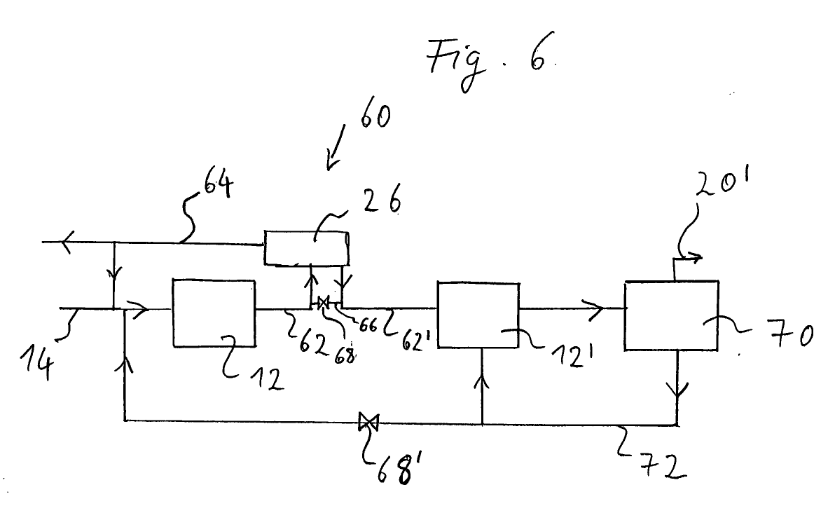

FIG. 6 a schematic view of a system for the purification of waste water in the paper making industry in accordance with a fifth embodiment of the present invention;

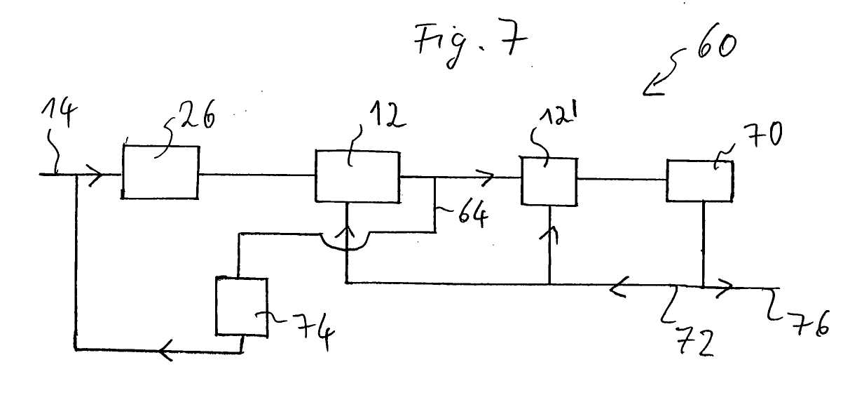

FIG. 7 a schematic view of a system for the purification of waste water in the paper making industry in accordance with a sixth embodiment of the present invention

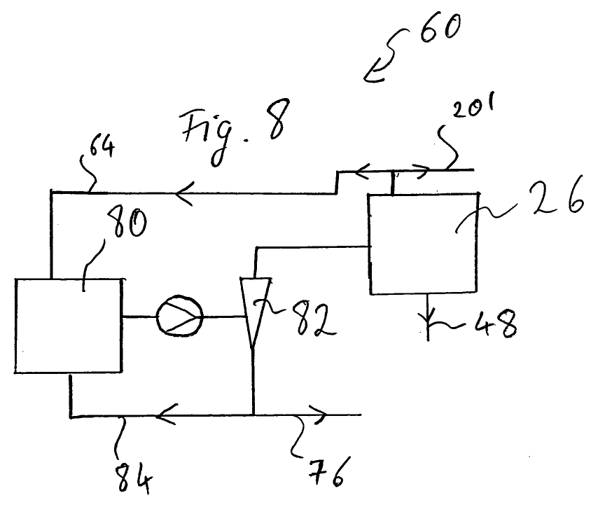

FIG. 8 a schematic view of a system for the purification of waste water in the paper making industry in accordance with a seventh embodiment of the present invention.

The apparatus 10 shown in FIG. 1 for the purification of waste water in accordance with the prior art includes an aerobic reactor 12 which has a waste water supply line 14, a gas supply line 16 for the supply of oxygen or of gas containing oxygen, such as air, which opens into an aeration device 18, as well as a waste water drainage line 20. The aerobic reactor 12 furthermore has a recirculation line 22 through which the medium contained in the aerobic reactor 12 is circulated via a mammoth pump effect. The recirculation line 22 can, as shown in FIG. 1, be arranged externally, i.e. outside the reactor 12, or internally, i.e. running in the aerobic reactor 12 (not shown). Finally, the aerobic reactor 12 has a coarse filter 24 which is disposed in front of the opening of the waste water drainage line 20 and through which solids can be filtered out of the waste water to be drained off.

In the operation of the apparatus 10, the waste water to be purified, which originates from a paper making factory, for example, is led continuously into the aerobic reactor 12 via the waste water supply line 14. At the same time, air which is introduced into and distributed in the reactor 12 via the aeration device 18 arranged at the opening of the gas supply line 16 and which mixes with the waste water to be purified is supplied continuously to the aerobic reactor 12 via the gas supply line 16. The aerated waste water to be purified is then guided upwardly through the reactor where it comes into contact with the aerobic microorganisms (not shown) held in suspension in the reactor 12 and provided on carriers, with the aerobic microorganisms at least partly breaking down the organic impurities contained in the waste water. The medium contained in the reactor 12 is circulated continuously via the recirculation line 22. The waste water purified by the aerobic microorganisms rises further upwardly in the reactor 12 and passes through the coarse filter 24 in which the carriers taken along and permeated with microorganisms are held back. After the coarse filter 24, the water is drained from the reactor 12 via the waste water drainage line 20. The drained water can be supplied to a further biological treatment stage (not shown) or to a post-clarification (not shown).

Since the carriers permeated with the microorganisms act as seed crystals, lime which is deposited on the carriers is formed from the hydrogen carbonate or carbonate ions contained in the waste water in the operation of the reactor 12. Furthermore, a stripping of carbon dioxide takes place by the air supply, which contributes to the lime precipitation. In addition, due to the metabolic activity of the aerobic microorganisms in the aerobic reactor 12, a displacement of the lime/carbonic acid balance takes place, from which likewise a lime precipitation onto carriers acting as seed crystals results, which increases their specific density. Due to the lime precipitation on the carriers, some of the carriers are deposited on the bottom of the reactor so that this portion no longer participates in the purification, which has a negative impact on the efficiency of the aerobic reactor 12.

Unlike the apparatus 10 in accordance with the prior art shown in FIG. 1, the apparatus 10 for the purification of waste water in accordance with the present invention shown in FIG. 2 has a dissolved air flotation device 26 shown bordered by dashed lines in FIG. 2 beside the aerobic reactor 12. In addition, the waste water to be purified is supplied to the apparatus 10 not via a waste water supply line 14 leading directly into the aerobic reactor 12, but rather indirectly via a waste water supply line 14 leading into the dissolved air flotation device 26.

The dissolved air flotation device 26 includes a pH setting device 28 to which a substance, for example sodium hydroxide solution, suitable for the setting of the pH of the waste water supplied via a part flow line 32 from the aerobic reactor 12 to the dissolved air flotation device 26 can be supplied via an inflow 30. In addition, the dissolved air flotation device 26 includes a dissolved air flotation reactor 34 in which lime is separated from the waste water by means of dissolved air flotation. For this purpose, the dissolved air flotation reactor 34 has a circuit line 36 which is connected to a mixing in unit 38 and to a gas dissolving unit 40. Precipitants and/or flocculation aids can be added to the mixing in unit 38 via the inflow lines 30′, 30″, whereas the gas dissolving reactor 40 is equipped with a pressurized gas supply line 42.

The waste water supply line 14 leads into a mixer unit 43 into which inflow lines 31, 31′ likewise open via which pH setting agents, precipitants and/or flocculation aids can be added to the waste water to be purified in the mixer unit 43. The waste water to be purified supplied to the apparatus 10 moves from the mixer unit 43 via the inflow line 46 into the dissolved air flotation reactor 34.

A return line 44 in which a cooling device (not shown) can optionally be provided and which leads into the inflow region of the aerobic reactor 12 is provided in the outflow region of the dissolved air flotation reactor 34.

In the operation of the apparatus 10 shown in FIG. 2, the waste water to be purified is led continuously via the waste water supply line 14 into the mixer unit 43 in which it is mixed with pH setting agents, precipitants and flocculation aids supplied to the mixer unit 43 via the inflow lines 31, 31′ so that conditions suitable for a lime precipitation from the waste water are set, with the set pH preferably amounting to between 7.5 and 8.5. The waste water pretreated in this manner is led continuously via the inflow line 46 from the mixer unit 43 into the dissolved air flotation reactor 34. In addition, a part flow of the purified waste water continuously removed from the aerobic reactor 12 via the line 20 is guided via a pump 47 into the pH setting device 28 in which the waste water is mixed with the pH setting agents supplied to the pH setting device 28 via the inflow line 30 and is set to conditions suitable for a lime precipitation. The portion of the part flow supplied to the pH setting device 28 via the part flow line 32 preferably amounts, with respect to the total flow taken out of the aerobic reactor 12 via the drain line 20, to 5 to 80% and particularly preferably to 30 to 50%. It is furthermore preferred for the pH of this part flow to be set by the addition of the pH setting agent, preferably sodium hydroxide solution, to 7.5 to 8.5. The concentration of sodium hydroxide solution after the addition of the pH setting agent can, for example, amount, with respect to a 50% by weight solution, to 0.2 to 0.6 l/m³. Subsequently the mixture thus generated is led via a dissolved air flotation supply line 46′ into the dissolved air flotation reactor 34.

Some of the liquid located in the dissolved air flotation reactor 34 is removed from the dissolved air flotation reactor 34 continuously via the circuit line 36 and this part flow is led through the mixing in unit 38 and the gas dissolving reactor 40 before the part flow is again guided back into the dissolved air flotation reactor 34. Precipitants and flocculation aids which support the precipitation of lime and the formation of lime flocculation suitably dimensioned for a separation from the waste water are mixed into the part flow in the mixing in unit 38 via the inflow lines 30′, 30″. Polyaluminum chloride can, for example, be used as the precipitant, whereas polyacrylamide is an example for a suitable flocculation aid. A pressurized gas, for example air or another gas containing oxygen or also a gas free of oxygen is added via the pressurized gas supply line 42 to the part flow in the gas dissolving reactor 40 provided downstream of the mixing in unit 38 for the purpose of preparation for the subsequent dissolved air flotation and the part flow mixed with the pressurized gas is pressurized before the part flow thus treated is guided back into the dissolved air flotation reactor 34. In the dissolved air flotation reactor 34, the pressurized mixture mixed with gas expands abruptly so that the gas present in dissolved form in the water bubbles out and rises upwardly in the form of gas bubbles in the dissolved air flotation reactor 34. At the same time, the lime located in the water forms flakes of suitable size and structure due to the precipitants and flocculation aids present so that they are driven to the water surface in the dissolved air flotation reactor 34 by the upwardly rising gas bubbles. While the lime sludge forming in this manner is removed from the dissolved air flotation reactor 34 via the sludge drainage line 48, the purified water liberated from lime, i.e. the softened water, is guided via the return line 44 into the inflow region of the aerobic reactor 12. The portion of the waste water flow 20 which is not led via the part flow line 32 into the dissolved air flotation device 26 is removed from the apparatus 10 via the waste water drainage line 20′.

Due to the precipitation and separation of the lime from the waste water supplied to the apparatus 10 via the waste water supply line 14 and due to the precipitation and separation of the lime from the part flow originating from the aerobic reactor 12 and supplied to the dissolved air flotation device 26 in the dissolved air flotation device 26, the water hardness of the waste water supplied into the aerobic reactor 12 via the return line 44 is reduced to a suitably low value so that no amounts of lime disturbing the function of the microorganisms are deposited in the aerobic reactor 12 so that the purification efficiency of the aerobic reactor 12 is optimized.

Since the waste water to be purified and supplied to the apparatus 10 via the waste water supply line 14 is first led into the dissolved air flotation device 26 before it is guided into the aerobic reactor 12 disposed downstream of the dissolved air flotation device 26, a microflotation device as a rule connected before the aerobic reactor 12 in the apparatus known from the prior art and acting as a device for the separation of particulate matter can be combined with the dissolved air flotation reactor 34. The costs for the apparatus 10 can thereby be substantially reduced.

In the apparatus shown in FIG. 2, two inflow lines 30, 31 for pH setting agents are provided from which the inflow line 30 opens into the part flow supplied via the part flow line 32 from the aerobic reactor 12 via the pH setting device 28 and the inflow line 31 opens via the mixer unit 43 into the waste water to be purified supplied via the waste water supply line 14. Instead of this, only one of the inflow lines 30, 31 can also be provided or instead of both lines, one inflow line for pH setting agents (not shown) leading directly into the dissolved air flotation reactor 34 can be provided. Equally, the supply line 31′ for precipitants and/or flocculation aids leading to the mixer unit 43 can be dispensed with so that the concentration of precipitants and/or flocculation aids takes place solely via the inflow lines 30′, 30″.

The apparatus 10 in accordance with a second embodiment of the present invention shown in FIG. 3 differs from that shown in FIG. 2 in that the part flow supplied to the dissolved air flotation device 26 from the aerobic reactor 12 via the part flow line 32 is not guided directly into the dissolved air flotation reactor 34 after the pH setting device 28, but rather first into the line 36′ led to the mixing in unit 38. In addition, a circuit line 36 is provided which leads from the dissolved air flotation reactor 34 to the line 36′ and which is provided with a valve 49 via which the circuit line 36 can be opened or closed. Alternatively to the embodiment shown in FIG. 3, the part flow supplied to the dissolved air flotation device 26 from the aerobic reactor 12 via the part flow line 32 can also be supplied after the pH setting device 28 via a suction stub of a pressure pump to the gas dissolving reactor 40. The water flow drained from the apparatus 10 via the waste water drainage line 20′ can be supplied to a further aerobic biological treatment stage (not shown) or to a post-clearing (not shown). The embodiment in accordance with the present invention shown in FIG. 3 is in particular suitable for the purification of waste water or process water from the paper making industry.

In contrast to the apparatus 10 shown in FIGS. 2 and 3, the waste water supply line 14 in the apparatus 10 in accordance with a third embodiment of the present invention shown in FIG. 4 is not provided downstream, but rather upstream of the aerobic reactor 12 and opens via a pump 47′ directly into the aerobic reactor 12. In the operation of this apparatus 10, the waste water to be purified is accordingly introduced into the aerobic reactor 12 in which the organic impurities contained in the waste water are broken down by the effect of aerobic microorganisms. The purified waste water is thereupon removed from the aerobic reactor 12 via the drainage line 20 and is separated into two part flows of which the one part flow is drained from the apparatus 10 via the part flow line 20′, whereas the other part flow is guided via the part flow line 32, via the pH setting device 28 and via the dissolved air flotation supply line 46 into the dissolved air flotation reactor 34 where lime is precipitated from the waste water and is separated from the waste water. Finally, the softened and purified waste water is led back into the aerobic reactor 12 via the return line 44. The lime content of the water flowing into the aerobic reactor 12 is thereby reduced by 30 to 60%, which prevents the formation of limescale in the interior of the aerobic reactor 12 or at least reduces it in a sufficient amount. The lime formation in the aerobic reactor 12 can be controlled by the setting of the degree of softening in the dissolved air flotation reactor 34. The embodiment in accordance with the present invention shown in FIG. 4 is in particular suitable for the purification of waste water or process water from the paper making industry.

The apparatus 10 shown in FIG. 5 differs from that shown in FIG. 4 in that the water flow removed from the aerobic reactor 12 via the drainage line 20 is completely introduced via the dissolved air flotation supply line 46 into the dissolved air flotation reactor 34; the water flow 20 is accordingly not divided into part flows. In a further difference to the apparatus 10 shown in FIG. 4, a water drainage line 50 is provided at the dissolved air flotation reactor 34 in the apparatus 10 shown in FIG. 5 and some of the liquid flow recirculated via the circuit line 36 is removed from the apparatus 10 to dispose of it or to reuse it. This method variant is in particular advantageous when a gas containing oxygen, preferably air, is used in the mixing in unit 38 because a so-called “flash oxidation” of the remainder of the organic material thereby simultaneously takes place in the dissolved air flotation reactor 34.

In FIG. 6, a system 60 is shown for the purification of waste water which contains two biological treatment stages, namely a first aerobic container 12 and a second aerobic reactor 12′. Downstream of the first reactor 12 and upstream of the second reactor 12′, a dissolved air flotation device 26 is arranged which is connected to the first reactor 12 via the line 62 and to the second reactor 12′ via the line 62′. In addition, a part flow return line 64 leads from the dissolved air flotation device 26 back to the first reactor 12. The line 62 is connected to the line 62′ via a connection line 66 which can be completely opened, partly opened and closed via a valve 68. Downstream of the second reactor 12′, a separation device 70 is provided via which sludge is separated from the purified water and is guided back via the sludge return line 72 into the first reactor 12 and/or into the second reactor 12′. The first reactor 12 can also be an anaerobic reactor, whereas the second reactor 12′ is necessarily an aerobic reactor.

In the operation of the system shown in FIG. 6, the waste water continuously supplied to the system 60 via the line 14 is purified in the first aerobic reactor 12 before it is softened in the dissolved air flotation device 26. While one part flow of the softened water is guided back into the first reactor 12, the other part flow is led into the second reactor 12′ and is further purified. A part flow of the water exiting the first reactor 12 can also be guided via the valve 68 directly into the second reactor 12′ while bypassing the dissolved air flotation device 26. The sludge separated in the separation device 70 is guided back into the first reactor 12 and/or into the second reactor 12′.

The system 60 shown in FIG. 7 for the purification of waste water differs from that shown in FIG. 6 in that the dissolved air flotation device 26 is arranged upstream of the first aerobic reactor 12. While a part flow of the water removed from the first reactor 12 is guided back into the dissolved air flotation device 26 via the part flow return line 64, the other part flow is led into the second aerobic reactor 12′. The sludge separated in the separation device 70 arranged downstream of the second reactor 12′ is guided back completely or partly into the first reactor 12 and/or into the second reactor 12′, whereas any excess sludge is removed from the apparatus 60 via the drainage line 76. An air saturation tank 74 is provided in the part flow return line 64.

In FIG. 8, a system 60 for the purification of waste water in accordance with a further embodiment is shown which has an aerobic, mixed tank 80 as the aerobic reactor downstream of which a hydrocylone 82 or a battery of hydrocyclones (not shown) is connected for the separation of sludge. In contrast to an MBBR, a mixed tank has a substantial portion of sludge in the removed water which is largely separated in advance in the hydrocyclone 82. Instead of the hydrocyclone 82, another compact phase separation unit (not shown) can also be used for the advance sludge separation. A sludge return line 84 leads from the hydrocyclone 82 into the mixed tank, whereas excess sludge is removed via the excess sludge drainage line 76 and the water separated in the hydrocyclone 82 is guided into a dissolved air flotation device 26. Some of the water softened in the dissolved air flotation device 26 is guided back into the mixed tank 80 via the part flow return line 64, whereas the other part flow is removed from the apparatus 60 via the drainage line 20′.

### REFERENCE NUMERAL LIST

10 apparatus for waste water purification

12, 12′ aerobic reactor

14 waste water supply line

16 gas supply line

18 aeration device

20, 20′ waste water drainage line

22 recirculation line

24 coarse filter

26 dissolved air flotation device

28 pH setting device

30, 30′, 30″ inflow line

31, 31′ inflow line

32 part flow line

34 dissolved air flotation reactor

36, 36′ (circuit) line

38 mixing in unit

40 gas dissolving reactor

42 pressurized gas supply line

43 mixer unit

44 return line into the aerobic reactor

46, 46′ dissolved air flotation supply line

47, 47′ pump

48 lime drainage line

49 valve

50 water drain line

60 system for waste water purification

62, 62′ line

64 part flow return line

66 connection line

68, 68′ valve

70 separation device

72 sludge return line

74 air saturation reactor

76 excess sludge drainage line

80 mixed tank

82 (hydro) cyclone

84 sludge return line

1-29. (canceled)

30. A method for the continuous purification of waste water, in particular for the continuous purification of waste water in the paper making industry, wherein oxygen or a gas containing oxygen and waste water to be purified are supplied to an aerobic reactor (12), the waste water is brought into contact with aerobic microorganisms in the aerobic reactor (12) to break down impurities contained in the waste water and the purified waste water is drained from the aerobic reactor (12),
characterized in that
at least some of the waste water is subjected to a dissolved air flotation step for the purpose of at least part softening before the supply into the aerobic reactor (12), with the waste water to be purified being continuously supplied before the supply into the aerobic reactor (12) to a dissolved air flotation device (26) in which the dissolved air flotation step is carried out and is there mixed with at least some of the waste water drained continuously from the aerobic reactor (12) and at least partly softened waste water is drained continuously from the dissolved air flotation device (26) and is supplied directly to the aerobic reactor (12), with the water hardness in the dissolved air flotation step being reduced by at least 40%, and with the apparatus in which the method is carried out including a sludge separation device (70) which is disposed downstream of the aerobic reactor (12) and from which a sludge return line (72) leads to the aerobic reactor (12).

31. A method in accordance with claim 30, characterized in that the waste water is set to a neutral or alkaline pH in the dissolved air flotation step, is dosed with gas and is pressurized before the waste water treated in this way is exposed to a reduced pressure.

32. A method in accordance with claim 31, characterized in that the waste water is set in the dissolved air flotation step to a pH between 7 and 10, preferably between 7 and 9 and particularly preferably between 7.5 and 8.5.

33. A method in accordance with claim 30, characterized in that at least one precipitant and/or at least one flocculation aid is added to the waste water before or during the dissolved air flotation step.

34. A method in accordance with claim 33, characterized in that the at least one precipitant is polyaluminum chloride.

35. A method in accordance with claim 33, characterized in that the at least one flocculation aid is polyacrylamide.

36. A method in accordance with claim 30, characterized in that the temperature of the waste water in it, in particular that of the waste water supplied to the aerobic reactor (12) is regulated and/or monitored.

37. A method in accordance with claim 30, characterized in that the aerobic reactor (12) is made as an MBBR.

38. A method in accordance with claim 30, characterized in that the waste water to be purified is treated before or after the treatment in the aerobic reactor (12) in one or more mixer aerobic and/or anaerobic reactors, with the total number of the aerobic and, optionally, anaerobic reactors preferably amounting to 2 to 6.

39. An apparatus for the continuous purification of waste water, in particular for the continuous purification of waste water in the paper making industry, comprising at least one reactor (12) for the aerobic purification of waste water having at least one supply line (14) for the supply of waste water to be purified into the reactor (12), at least one gas supply line (16) for the supply of oxygen or for the supply of a gas containing oxygen into the reactor (12) as well as at least one drainage line (20) for the drainage of purified waste water from the reactor (12),
characterized in that
the apparatus (10) furthermore includes a dissolved air flotation device (26) which has a dissolved air flotation reactor (34) and which is connected to the at least one drainage line (20) of the aerobic reactor (12) via a dissolved air flotation supply line (46′) such that at least a part flow of the purified waste water draining from the aerobic reactor (12) via the drain line (20) can be guided into the dissolved air flotation reactor (34), with the dissolved air flotation device (26) including at least one supply line (30, 31) for a pH setting agent and the dissolved air flotation device (26) furthermore including a line (44) leading from the dissolved air flotation reactor (34) directly to the aerobic reactor (12), and with the apparatus (10) including a sludge separation device (70) which is disposed downstream of the aerobic reactor (12) and from which a sludge return line (72) leads to the aerobic reactor (12).

40. An apparatus in accordance with claim 39, characterized in that the dissolved air flotation device (26) has at least one supply line (30′, 30″, 31′) for a precipitant and/or a flocculation aid.

41. An apparatus in accordance with claim 39, characterized in that the dissolved air flotation device (26) has at least one supply line (42) for a pressurized gas.

42. An apparatus in accordance with claim 41, characterized in that the dissolved air flotation device (26) has a gas dissolving device (40) which is connected to the dissolved air flotation reactor (34) via a line (36, 36′) and into which the pressurized gas line (42) opens.

43. An apparatus in accordance with claim 42, characterized in that the waste water supply line (14) opens into a mixer unit (43) and opens from there via a supply line (46) into the dissolved air flotation reactor (34), with the mixer unit (43) preferably having a supply line (31) for pH setting agents and/or a supply line (31′) for precipitants and/or flocculation aids.

44. An apparatus in accordance with claim 39, characterized in that the line (44) of the dissolved air flotation device (26) opens directly into the inflow region of the aerobic reactor (12).

45. An apparatus in accordance with claim 39, characterized in that a temperature setting device is provided in it which is preferably arranged in the line (44) and which is preferably a heat exchanger or a cooling device, for example a cooling tower.

46. An apparatus in accordance with claim 39, characterized in that the gas supply line (16) of the aerobic reactor (12) opens into an aeration device (18) which is preferably made as a jet aeration, as a volume aeration or as a surface aeration.

47. An apparatus in accordance with claim 39, characterized in that the apparatus (10) includes one or more further aerobic reactors (12′) and/or anaerobic reactors in addition to the aerobic reactor (12).
